(19) United States
(12) Patent Application Publication
(10) Pub. No.: US 2022/0161206 A1
(43) Pub. Date: May 26, 2022

(54) HEMPCRETE SPRAYING DEVICE

(71) Applicant: Robert Paul Camille Leonardi, Austin, TX (US)

(72) Inventor: Robert Paul Camille Leonardi, Austin, TX (US)

(21) Appl. No.: 17/534,090

(22) Filed: Nov. 23, 2021

Related U.S. Application Data
(60) Provisional application No. 63/198,926, filed on Nov. 23, 2020.

(51) Int. Cl. B01F 25/72; B05B 7/14; B01F 25/00; B01F 101/28

(52) U.S. Cl. CPC B01F 25/72; B05B 7/1404; B01F 2101/28; B01F 2025/9191; B05B 7/149

(57) ABSTRACT

A nozzle includes a main chamber defining a first internal space, a first inlet defined in a first end of the main chamber to couple to a material sprayer, a second inlet to receive a solid material into the main chamber, and an outlet defined in a second end of the main chamber. The first inlet upstream from the second inlet to allow a fluid material to enter the main chamber before the solid material. The main chamber configured to mix the solid material with the fluid material.

### CROSS-REFERENCE TO RELATED APPLICATION(S)

This application claims priority to U.S. Provisional Application No. 63/198,926 filed on Nov. 23, 2020 and entitled “Hemperete Spray Nozzle,” which is incorporated herein by reference in its entirety.

### TECHNICAL FIELD

The present disclosure relates generally to building construction. Specifically, the present disclosure relates to systems and methods for dispensing a mixture of a fluid material and a solid material onto a surface.

### BACKGROUND

Construction of structures has been ubiquitous since time immemorial. In some instances, construction of new and existing structures may include the spraying of a binding material (e.g., a cementitious material) to form part of a wall or similar architectural element. This allows for the architectural element to obtained additional features or functions such as added strength, different texture, flatter surfaces, insulating properties, other features or functions, and combinations thereof. Some spray devices used to dispense the binding material may not effectively or efficiently dispense the binding material onto the surface being treated. Further, some spray devices that utilize a solid material that is mixed into the binding material may not be able to effectively mix and dispense the binding material and the solid material such that the architectural element is constructed as intended.

### BRIEF DESCRIPTION OF THE DRAWINGS

The detailed description is set forth below with reference to the accompanying figures. In the figures, the left-most digit(s) of a reference number identifies the figure in which the reference number first appears. The use of the same reference numbers in different figures indicates similar or identical items. The systems depicted in the accompanying figures are not to scale and components within the figures may be depicted not to scale with each other.

FIG. 1 illustrates a system including a nozzle for mixing and dispensing a binding material and a solid material, according to an example of the principles described herein.

FIG. 2 illustrates an isometric view of a first portion of a main chamber of the nozzle of FIG. 1, according to an example of the principles described herein.

FIG. 3 illustrates a top view of the first portion of FIG. 2, according to an example of the principles described herein.

FIG. 4 illustrates a first side view of the first portion of FIG. 2, according to an example of the principles described herein.

FIG. 5 illustrates a second side view of the first portion of FIG. 2, according to an example of the principles described herein.

FIG. 6 illustrates a bottom view of the first portion of FIG. 2, according to an example of the principles described herein.

FIG. 7 illustrates an isometric view of a second portion of the main chamber of the nozzle of FIG. 1, according to an example of the principles described herein.

FIG. 8 illustrates a top view of the second portion of FIG. 7, according to an example of the principles described herein.

FIG. 9 illustrates a side view of the second portion of FIG. 7, according to an example of the principles described herein.

FIG. 10 illustrates a bottom view of the second portion of FIG. 7, according to an example of the principles described herein.

FIG. 11 illustrates an isometric view of a handle coupler for coupling the first portion of FIG. 2 and the second portion of FIG. 7, according to an example of the principles described herein.

FIG. 12 illustrates an isometric view of the handle coupler of FIG. 11, according to an example of the principles described herein.

FIG. 13 illustrates a top view of the handle coupler of FIG. 11, according to an example of the principles described herein.

FIG. 14 illustrates a top view of the handle coupler of FIG. 11, according to an example of the principles described herein.

FIG. 15 illustrates a first side view of the handle coupler of FIG. 11, according to an example of the principles described herein.

FIG. 16 illustrates a second side view of the handle coupler of FIG. 11, according to an example of the principles described herein.

FIG. 17 illustrates an isometric view of a dispenser bracket for coupling a material sprayer to the first portion of FIG. 2 of the main chamber of the nozzle of FIG. 1, according to an example of the principles described herein.

FIG. 18 illustrates a first side view of the dispenser bracket of FIG. 17, according to an example of the principles described herein.

FIG. 19 illustrates a second side view of the dispenser bracket of FIG. 17, according to an example of the principles described herein.

FIG. 20 illustrates an isometric view of a first adapter for coupling to an outlet of the nozzle of FIG. 1, according to an example of the principles described herein.

FIG. 21 illustrates a side view of the first adapter of FIG. 20, according to an example of the principles described herein.

FIG. 22 illustrates an isometric view of a second adapter for coupling to an outlet of the nozzle of FIG. 1, according to an example of the principles described herein.

FIG. 23 illustrates an isometric view of a 45 degree (°) adapter for coupling to an outlet of the nozzle of FIG. 1, according to an example of the principles described herein.

FIG. 24 illustrates an isometric view of a wide adapter couplable to the outlet of the nozzle of FIG. 1, according to an example of the principles described herein.

FIG. 25 illustrates a bottom view of the wide adapter of FIG. 24, according to an example of the principles described herein.

FIG. 26 illustrates a top view of the wide adapter of FIG. 24, according to an example of the principles described herein.

FIG. 27 illustrates an isometric view of a long output tube couplable to the outlet of the nozzle of FIG. 1, according to an example of the principles described herein.

### DESCRIPTION OF EXAMPLE EMBODIMENTS

As mentioned above, a spray device utilized in the dispensing of a binding material along with a solid material may not function in a manner that effectively causes the combined material to form the intended architectural element. The present systems and methods include a spray nozzle that may be coupled to a material sprayer. The spray nozzle may include a main chamber in which a binding material dispensed by the material sprayer into the main chamber and a solid material dispensed by a solid materials blower into the main chamber may be mixed to form a homogeneous amalgam of the binding material and the solid material. The homogeneous mixture may be dispensed out of the main chamber via air pressure provided by the material sprayer and/or the solid materials blower. A spray head may be coupled to an outlet of the main chamber. The spray head may include a tapering shape that creates a relatively higher pressure differential therein to force the homogeneous mixture out of the spray nozzle and onto a surface of the architectural element in a uniform manner.

### Overview

Examples described herein provide a hemperete spraying device. The hemperete spraying device may include a spray nozzle. The spray nozzle may include a main chamber defining a first internal space, a first inlet defined in a first end of the main chamber, a second inlet to receive a solid material into the main chamber, and an outlet defined in a second end of the main chamber. The hemperete spraying device may also include a material sprayer coupled to a first end of the main chamber to dispense a fluid material. The material sprayer may be coupled to the first end of the main chamber upstream from the second inlet, and the main chamber configured to mix the solid material with the fluid material.

The hemperete spraying device may further include a spray head coupled to the outlet. The spray head includes a second internal space. The spray head includes a cylindrical interface to interface with the outlet, a tapering body including a first side, a second side, a third side, and a fourth side, and a mouth. The cylindrical interface, the first side, the second side, the third side, the fourth side, and the mouth define the second internal space.

The tapering body may include the first side and the third side, the first side and the third side being opposite with respect to one another. The second side and the fourth side are opposite with respect to one another. The first side and the third side taper from the cylindrical interface to the mouth such that a first distance between the first side and the third side at the cylindrical interface is larger with respect to a second distance between the first side and the third side at the mouth. The mouth includes a rectangular cross section. The main chamber includes an oval cross section.

The solid material may include a plant-based material. The solid material may include hemp, hemp hurd, kenaf, chaff, cellulose, fibers, straw, wheat stalk, oat stalk, rye stalk, barley stalk, buckwheat stalk, and combinations thereof. In one example, the solid material may also include man made materials. The fluid material may include a binding material to bind the solid material. The binding material may include a cementitious material, a concrete, a plaster, a lime binder, a clay, a stabilized soil, geopolymers, and combinations thereof. The spray nozzle may include a Browning nozzle.

Examples described herein also provide a nozzle including a main chamber defining a first internal space, a first inlet defined in a first end of the main chamber to couple to a material sprayer, a second inlet to receive a solid material into the main chamber, and an outlet defined in a second end of the main chamber. The first inlet upstream from the second inlet to allow a fluid material to enter the main chamber before the solid material, and the main chamber configured to mix the solid material with the fluid material.

The nozzle may further include a spray head coupled to the outlet, the spray head including a second internal space. The spray head includes a cylindrical interface to interface with the outlet, a tapering body including a first side, a second side, a third side, and a fourth side, and a mouth. The cylindrical interface, the first side, the second side, the third side, the fourth side, and the mouth define the second internal space.

The tapering body may include the first side and the third side. The first side and the third side being opposite with respect to one another. The second side and the fourth side are opposite with respect to one another. The first side and the third side taper from the cylindrical interface to the mouth such that a first distance between the first side and the third side at the cylindrical interface is larger with respect to a second distance between the first side and the third side at the mouth.

The mouth includes a rectangular cross section. The main chamber includes an oval cross section. The main chamber and the mouth include a wall thickness between 0.1 millimeters (mm) and 50 mm. The mouth may include a width of between 100 mm and 600 mm, and a height of between 20 mm and 100 mm. The first inlet is configured to couple to the material sprayer, the material sprayer including a Browning nozzle.

Additionally, the techniques described in this disclosure may be performed as a method and/or by a system having non-transitory computer-readable media storing computer-executable instructions that, when executed by one or more processors, performs the techniques described above.

### Example Embodiments

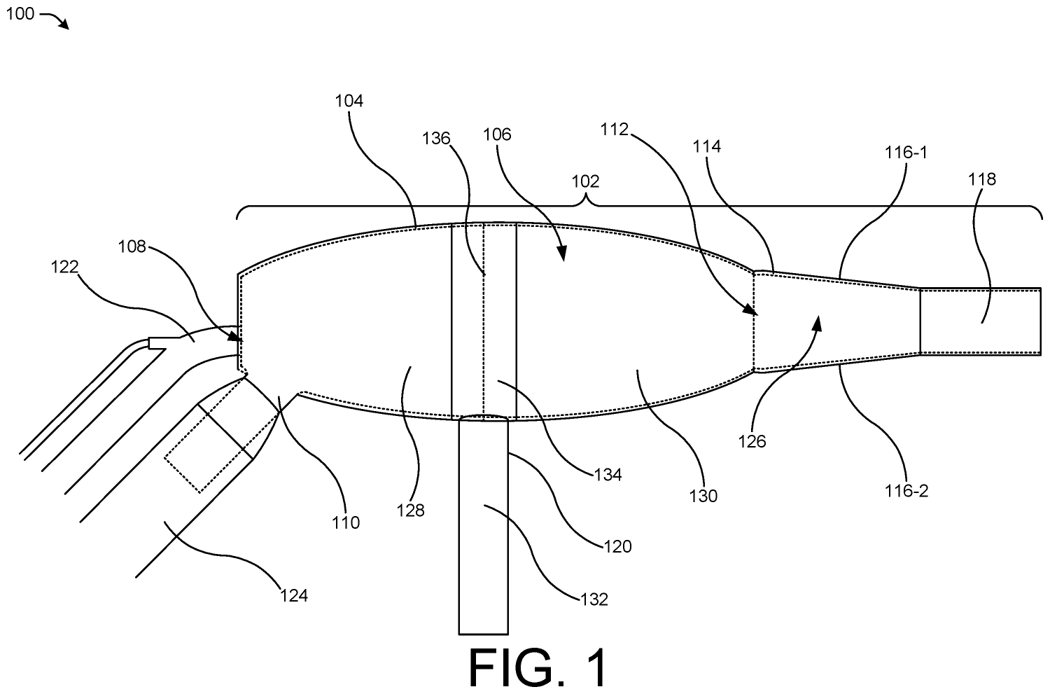

Turning now to the figures, FIG. 1 illustrates a system 100 including a nozzle 102 for mixing and dispensing a binding material and a solid material, according to an example of the principles described herein. The system 100 includes the nozzle 102 coupled to two separate material dispensers. A first material dispenser may include a fluid material dispenser 122 coupled to a first inlet 108 defined in a main chamber 104 of the nozzle 102. As depicted in FIG. 1, the main chamber 104 may include a wall that forms a first interior space 106 therein as indicated by the dashed lines. The fluid material dispenser 122 may dispense a binding material into a first interior space 106 of the main chamber 104. The binding material may include, for example, a cementitious material, a concrete, a plaster, a lime binder, a clay, a stabilized soil, other binding materials, geopolymers, and combinations thereof. This binding material is used to bind together solid materials also introduced into the first interior space 106 of the main chamber 104 as described herein. In one example, the fluid material dispenser 122 may include spraying device such as a plaster sprayer, a stucco sprayer, a Browning nozzle or other spraying device that may be used to spray fluids including fluids of relatively higher viscosity relative to, for example, water such as the aforementioned binding material(s).

A second material dispenser may include a solid material dispenser 124 coupled to the nozzle 102 at a second inlet 110. In one example, the first inlet 108 may be located at a first or rear end of the main chamber 104 of the nozzle 102 and the second inlet 110 may be located away from the first or rear end of the main chamber 104 of the nozzle 102 and may be located underneath of the main chamber 104 adjacent the first inlet 108. The second inlet 110 may include a cylindrical extension that extends from the main chamber 104. The solid material dispenser 124 may be coupled to the cylindrical extension of the second inlet 110. The solid material dispenser 124 may dispense a solid material into the first interior space 106 of the main chamber 104. The solid material may include, for example, a plant-based material, hemp, hemp hurd, kenaf, chaff, cellulose, fibers, straw, wheat stalk, oat stalk, rye stalk, barley stalk, buckwheat stalk, other plant-based material, and combinations thereof. This solid material is used as a filler for the binding material that provides a reduction in heat transfer (e.g., the transfer of thermal energy between objects of differing temperature) including, for example, thermal conduction, thermal convection, thermal radiation, and transfer of energy by phase changes. In one example, the solid material dispenser 124 may include a solid material spraying device such as an insulation blower or other solid material conveying device that may be used to move solid material through a hose and into the main chamber 104.

In one example, the mixture obtained within the main chamber 104 of the nozzle 102 as the binding material(s) and the solid material(s) are mix may be referred to as hemperete. The hemperete may be any bio-composite made of the inner woody core of any combination of the aforementioned solid material(s) mixed with any combination of the aforementioned binding material(s). In one example, the hemperete may include the inner woody core of hemp referred to as the shiv serving as the solid material, and a lime-based fluid binder serving as the binding material. In this example, the shiv may include a high silica content which allows it to bind well with the lime-based fluid binder. This property is unique to hemp among all natural fibers. The resulting mixture is a lightweight cementitious insulating material weighing about a seventh or an eighth of the weight of concrete, for example. Because fully cured hemperete blocks, for example, float in water, hemperete, although not being used as a structural element, may, instead, be used as insulating infill between the frame members of a structure such as the wood stud framing within the wall of a house. In this example, loads placed on the wall may be carried by internal wood stud framing while the hemperete serves to insulate between the wood stud framing.

In other systems other than the present systems and methods, the mixture of the fluid material(s) and the solid material(s) may be performed prior to pumping through a hose to a nozzle. In these non-inventive examples, the materials may be mixed in mortar mixers, for example, and stuffed by hand into the wall cavities. In other examples, the pre-mixed hemperete may be forced through a hose via air pressure and sprayed onto the target surfaces. However, because the pre-mixed hemperete has such a high viscosity and weight, the hemperete may not be effectively applied to the surface without significant blowback or overspray of the material to other areas where application is occurring. Further, these legacy systems may suffer from significant clogging and difficult cleanup procedures. Because the present systems and methods allow for the mixing of the solid material(s) and the binding material(s) to occur within the main chamber, the mixture may be effectively subjected to laminar flow out of the nozzle 102 resulting in a more effective spray pattern exiting from the nozzle 102 little or no blowback or overspray of the material.

As the binding material(s) from the fluid material dispenser 122 and the solid material(s) from the solid material dispenser 124 are dispensed into the first interior space 106 of the main chamber 104, the binding material(s) and the solid material(s) are mixed. The mixing may be effectuated via the shape of the first interior space 106 of the main chamber 104. In the examples described herein, the main chamber 104 may include an approximately oval cross-section such that the main chamber 104 has approximately an ovoid shape. As depicted in the figures, the ovoid shape of the main chamber 104 may include truncated ends where the main chamber 104 interfaces with the fluid material dispenser 122 at a first end and interfaces with a spray head 114 coupled to the main chamber 104 at a second end. The fluid material dispenser 122 and/or the solid material dispenser 124 may provide a force in the form of air pressure that causes the binding material(s) and the solid material(s) to be mixed within the first interior space 106 of the main chamber 104 and expelled out of the nozzle 102 via the spray head 114. In one example, the fluid material dispenser 122 may include and/or be fluidically coupled to a separate air pressure hose attached thereto to provide at least a portion of the air pressure utilized in moving the binding material(s) into the first interior space 106 of the main chamber 104, assisting in the mixing of the binding material(s) and the solid material(s) within the first interior space 106, and/or expelling the mixture out of the nozzle 102 via the spray head 114. Further, in one example, the solid material dispenser 124 may be fluidically coupled to a blower to provide at least a portion of the air pressure utilized in moving the solid material(s) into the first interior space 106 of the main chamber 104, assisting in the mixing of the binding material(s) and the solid material(s) within the first interior space 106, and/or expelling the mixture out of the nozzle 102 via the spray head 114.

In one example, the nozzle 102 may include the spray head 114. The spray head 114 may be fluidically coupled to the main chamber 104 via an outlet 112 defined in the second end of the main chamber 104. The spray head 114 may be used to assist in the creation of laminar air flow via which the then mixed binding material(s) and solid material(s) are expelled from the nozzle 102. In the examples described herein, the spray head 114 may be an attachment to the main chamber 104 and may be switched out with other, differently-shaped outlets. In one example, the spray head 114 may include a top side 116-1 and a bottom side 116-2 that oppose one another. The top side 116-1 and the bottom side 116-2 may have planar surfaces that are not parallel with respect to one another, but, instead, are tapering toward a mouth 118 of the spray head. This creates the laminar air flow that causes the mixture of the binding material(s) and solid material(s) to be expelled from the spray head 114.

The mouth 118 of the spray head 114 may include a rectangular cross-section. Further, the mouth 118 may have a width of between 100 mm and 600 mm and a height of between 20 mm and 100 mm. The shape and size of the spray head 114 including the top side 116-1 and the bottom side 116-2 and the mouth 118 creates the laminar flow through the spray head 114 described herein. This laminar flow, in turn, creates a spray pattern of the mixture of the fluid material(s) and the solid material(s) that creates a more efficient coating of the fiber along a target surface.

In one example, the spray head 114 is removably coupled to the main chamber 104 in a manner that does not deform or destroy either the spray head 114 and/or the main chamber 104. This allows for a different spray head 114 having at least one different dimension. For example, a replacement spray head 114 may be coupled to the main chamber 104 where the replacement spray head 114 includes a mouth 118 with different dimensions such as, for example, a shorter or wider width and/or a shorter or wider height. In one example, the spray head 114 may include one or more male or female coupling interfaces that are configured to coupled with a corresponding one or more male or female coupling interfaces formed on the main chamber 104 at the outlet 112.

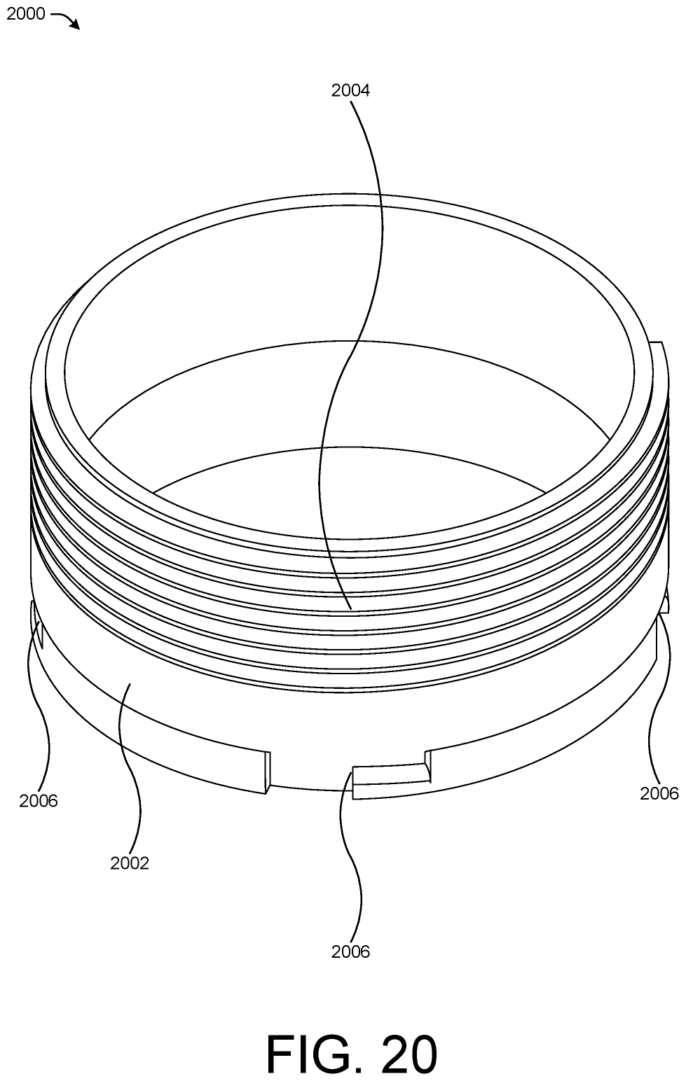

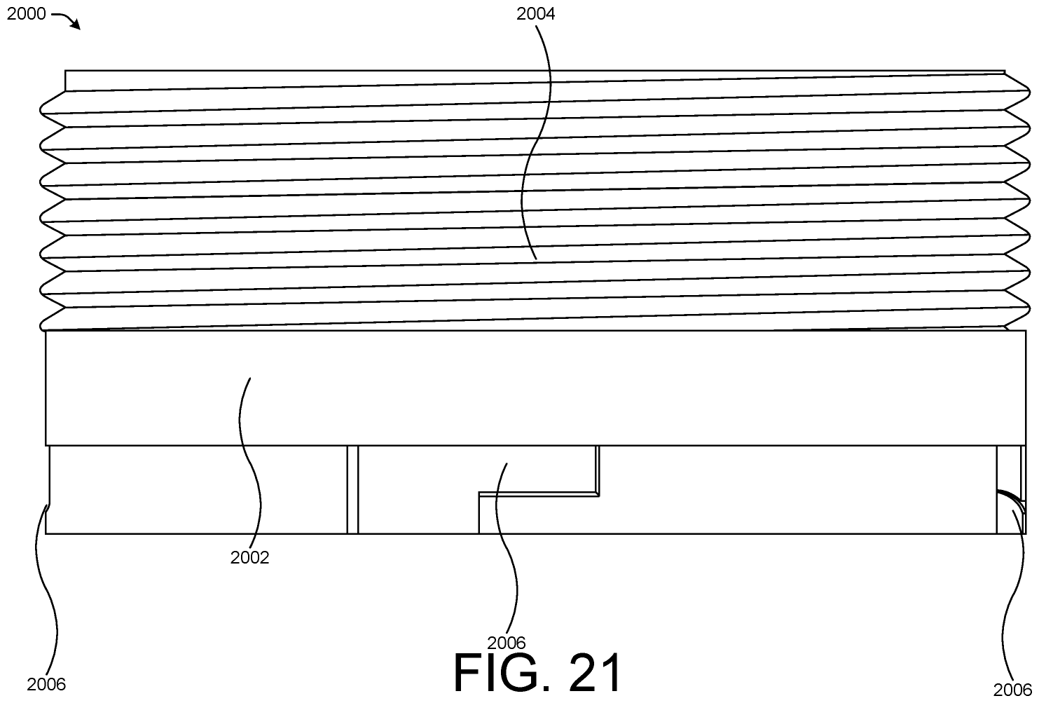

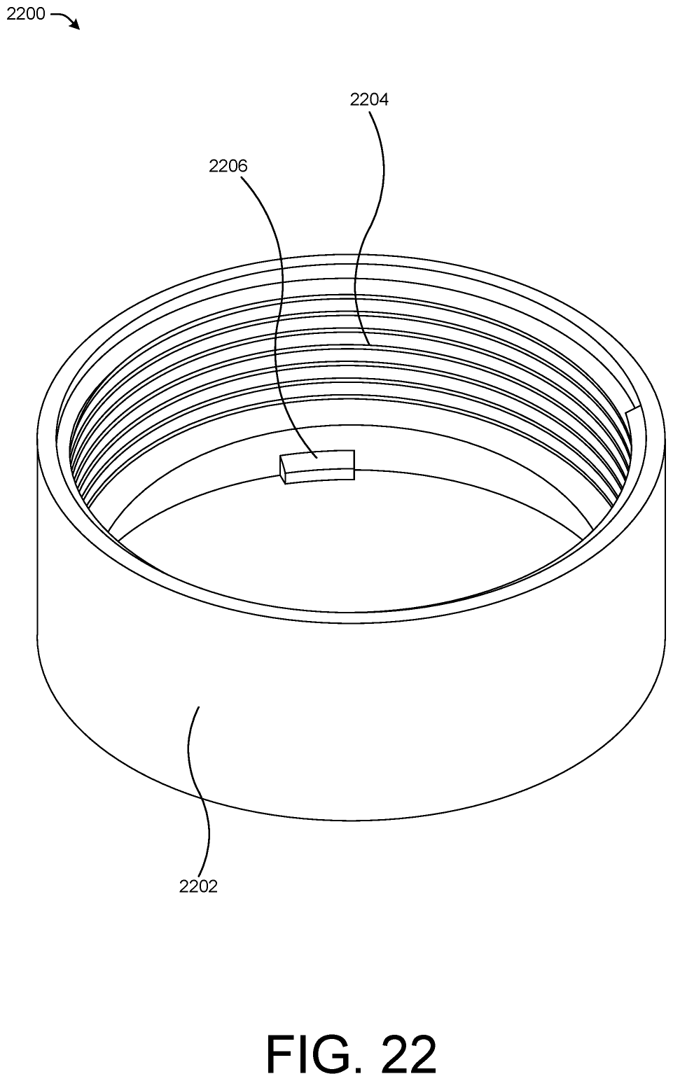

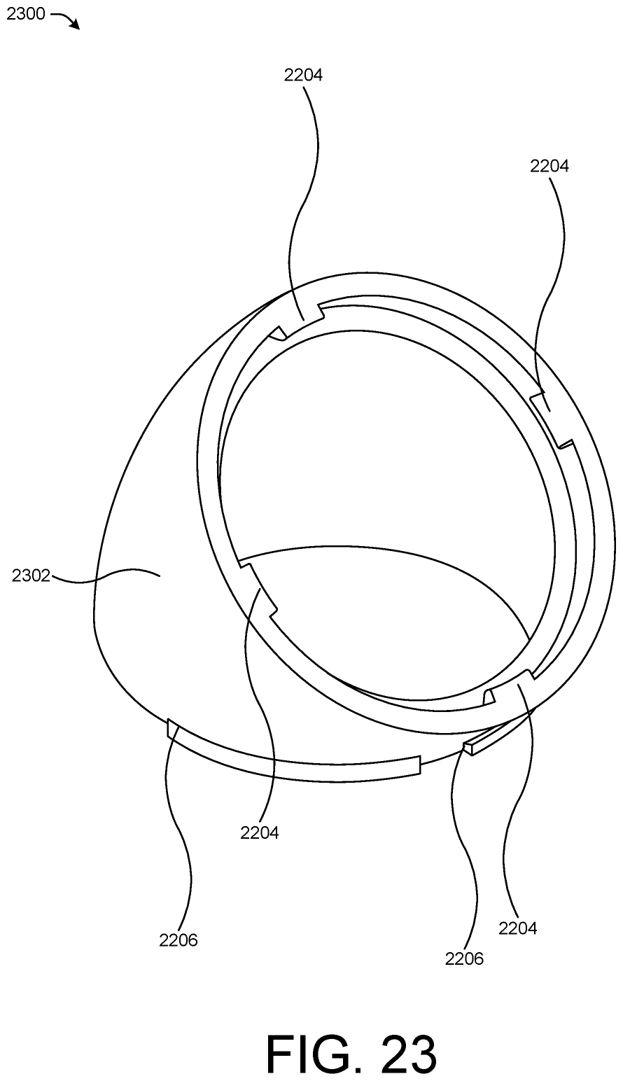

In one example, one or more intermediary coupling devices may be disposed between the main chamber 104 and the spray head 114 in order to create an extended distance between the main chamber 104 and the spray head 114 and/or provide orientation of the spray head 114 at an angle with respect to the main chamber 104. For example, a first adapter 2000 depicted in FIGS. 20 and 21, a second adapter 2200 depicted in FIG. 22, and a 45 degree (°) adapter 2300 depicted in FIG. 23 may be coupled directly or indirectly to the main chamber 104. In one example, these intermediary coupling devices may be used to couple the fluid material dispenser 122 and/or the solid material dispenser 124 to the main chamber 104 in instances where the interface of the fluid material dispenser 122 and/or the solid material dispenser 124 are of a different type or configuration of the coupling interface of the main chamber 104.

Any spray head 114 that may be coupled to the main chamber 104 may be referred to as an attachment to the main chamber 104 of the nozzle 102. As described herein, the spray head 114 may also include a generally cylindrical shape such as a tubular shape to provide for a different laminar flow and/or spray pattern from the main chamber 104. In one example, the main coupling interfaces between the main chamber 104 and the spray head(s) 114 couplable to the main chamber 104 as well as the coupling interfaces between the main chamber 104 and the fluid material dispenser 122 and/or the solid material dispenser 124 may include, for example, male and female threadings, locking tabs and indentations, elastic or deformable elements that retain their shape once deflected around one another, mechanical fasteners such as screws, bolts, nuts, clamps, etc., and other coupling means. Further, in one example, the coupling between the main chamber 104 and the spray head 114, the fluid material dispenser 122 and/or the solid material dispenser 124 may include an engineering fit such as, for example, a clearance fit (e.g., one of a loose running fit, a free running fit, a close running fit, a sliding fit, and a location fit), a transition fit (e.g., one of a similar fit, and a fixed fit), and an interference fit (e.g., one of a press fit, a driving fit, and a forced fit). The engineering fit may define a clearance between two mating parts (e.g., the main chamber 104 and the spray head 114, the fluid material dispenser 122 and/or the solid material dispenser 124), and the size of this clearance determines whether the parts can, at one end of the spectrum, move or rotate independently from each other or, at the other end, are temporarily or permanently joined together. In this manner, the coupling parts may create a single running fluid channel from the fluid material dispenser 122 and/or the solid material dispenser 124, through the first interior space 106 of the main chamber 104, and through the second interior space 126 of the spray head 114.

The nozzle 102 may further include a handle coupler 120. The handle coupler 120 includes a handle 132 that allows the user to grasp and control the nozzle 102. In one example, any number of additional handles may be coupled to the nozzle 102. Further, in one example, the main chamber 104 may be divided into two halves or hemispheres including a first portion 128 as a rear half and a second portion 130 as a front half as defined by the dashed line 136.

In one example, the handle coupler 120 may include a dual sided coupling interface 134 that couples the first portion 128 to the second portion 130 such that the coupling interface 134 is an intermediary element to the first portion 128 to the second portion 130. Stated another way, the first portion 128 may be coupled to a first side of the handle coupler 120 and the second portion 130 may be coupled to a second side of the handle coupler 120. In this example, the handle coupler 120 may include a first coupling means to couple to the first portion 128 and a second coupling means to couple to the second portion 130. More details regarding the handle coupler 120 is described herein.

Alluded to above, in one example, the nozzle 102 may be connected as pieces of a whole where these several elements are coupled to one another. These separate elements may include the first portion 128, the second portion 130, the handle coupler 120, the spray head 114, and other elements of the nozzle 102 described herein. Further, as indicated by the dashed lines in FIG. 1, the spray head 114 includes walls that form a second interior space 126 that is fluidically coupled to the interior space 106. Similar dashed lines are used to indicate the walls of the main chamber 104. The walls of the main chamber 104 and the spray head 114 may have a thickness of approximately between 0.1 millimeters (mm) and 50 mm.

In one example, the main chamber 104, the spray head 114 and the handle coupler 120 may be made of any material suitable for transmission of fluids and solids therethrough. For example, the material of the main chamber 104, the spray head 114 and the handle coupler 120 may include metals, metal alloys, plastics, fiber glass, fiber embedded materials, and composites, among other materials. Having described the system 100 including the nozzle 102 in connection with FIG. 1, we will now describe the individual elements of the system 100.

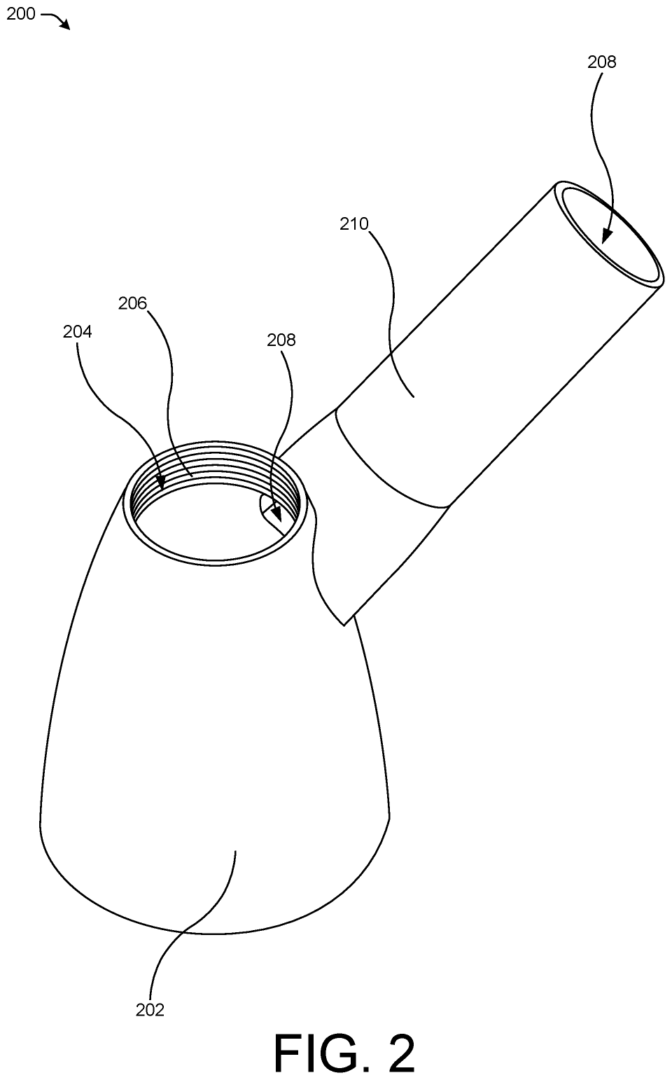

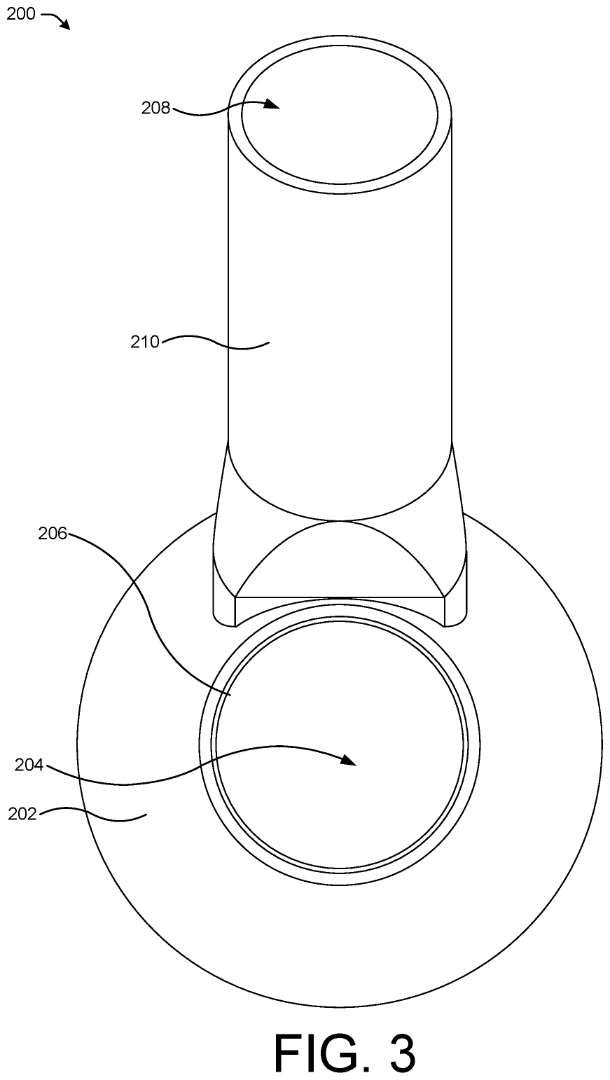

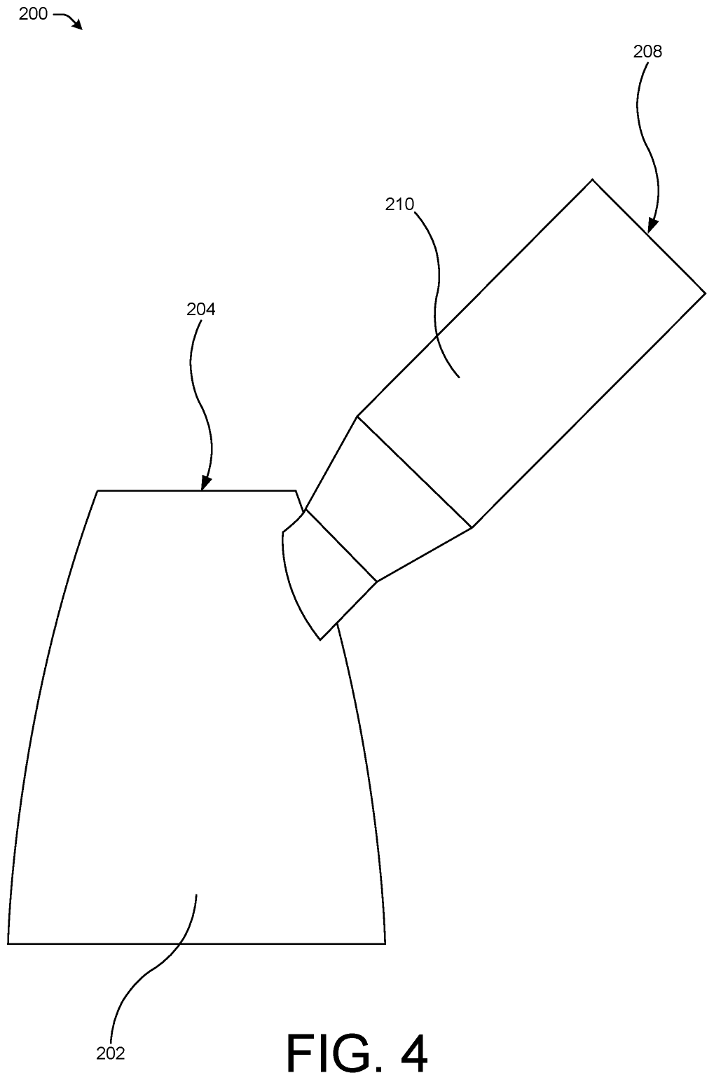

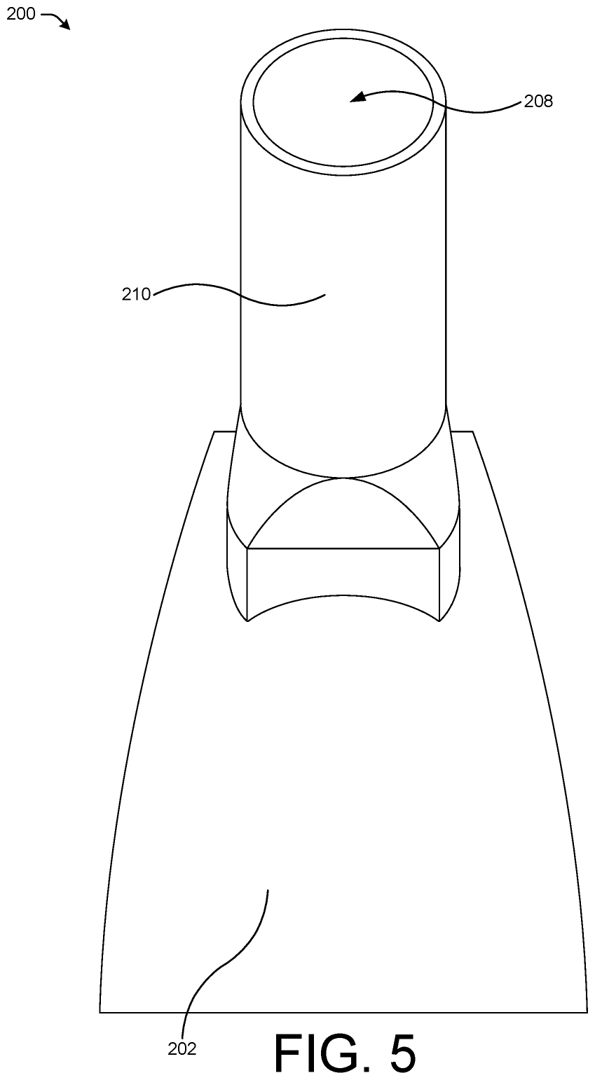

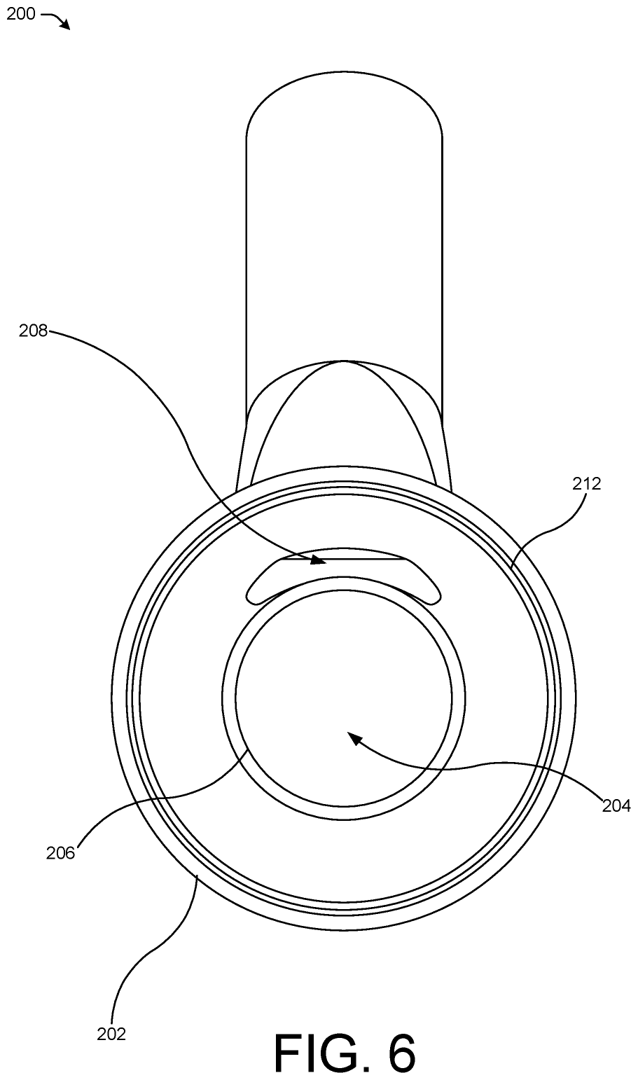

FIG. 2 illustrates an isometric view of a first portion 200 (e.g., the first portion 128 of FIG. 1) of the main chamber 104 of the nozzle 102 of FIG. 1, according to an example of the principles described herein. FIG. 3 illustrates a top view of the first portion 200 of FIG. 2, according to an example of the principles described herein. FIG. 4 illustrates a first side view of the first portion 200 of FIG. 2, according to an example of the principles described herein. FIG. 5 illustrates a second side view of the first portion 200 of FIG. 2, according to an example of the principles described herein. FIG. 6 illustrates a bottom view of the first portion 200 of FIG. 2, according to an example of the principles described herein.

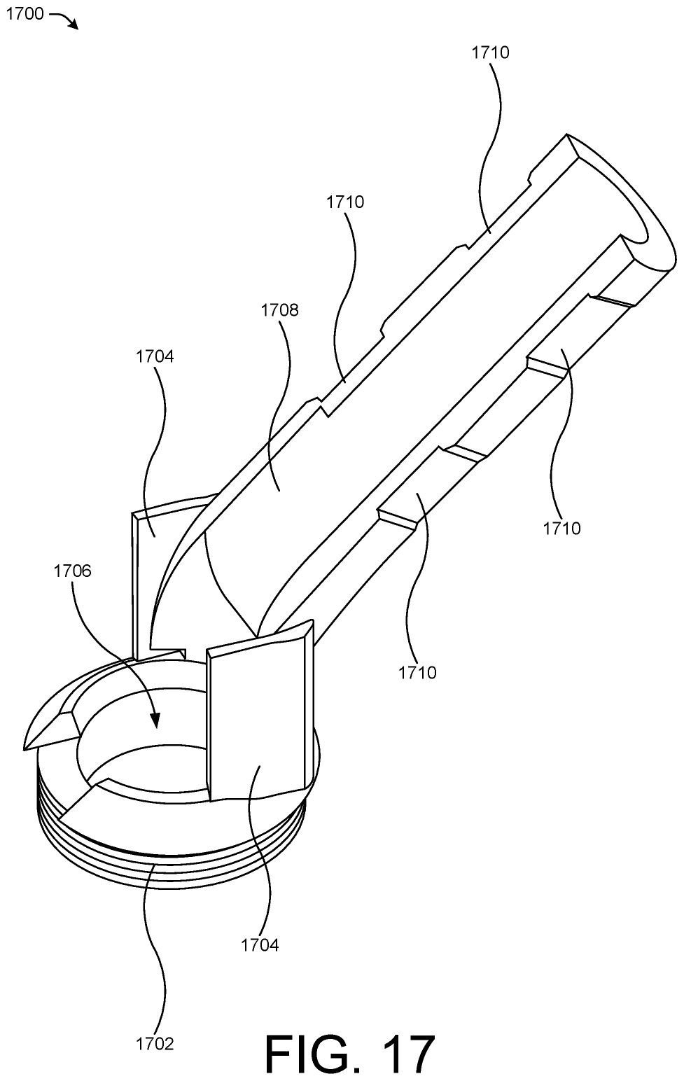

As depicted in FIGS. 2 through 6, the first portion 200 includes a body 202 that forms the first half or hemisphere of the main chamber 104. Further, the first portion 200 includes a first inlet 204 defined in the rear of the first portion 200. In one example, the first inlet 204 may include first threads 206 to threadingly couple a dispenser bracket (e.g., the dispenser bracket of FIGS. 17-19) to the first portion 200 the fluid material dispenser 122. In one example, the first threads 206 are female threads that mate with the corresponding threads of a dispenser bracket. As described in more detail herein, the dispenser bracket supports the fluid material dispenser 122 and couples the fluid material dispenser 122 to the first portion 200 the fluid material dispenser 122.

The first portion 200 may further include the second inlet 210 (e.g., the second inlet 110 of FIG. 1). The second inlet 210 may include a channel 208 through which the solid materials are introduced into the main chamber 104. The solid material dispenser 124 may be coupled to the second inlet 210 via an engineering fit as described herein. In one example, the solid material dispenser 124 may be coupled to the second inlet 210 via any coupling means or methods as described herein.

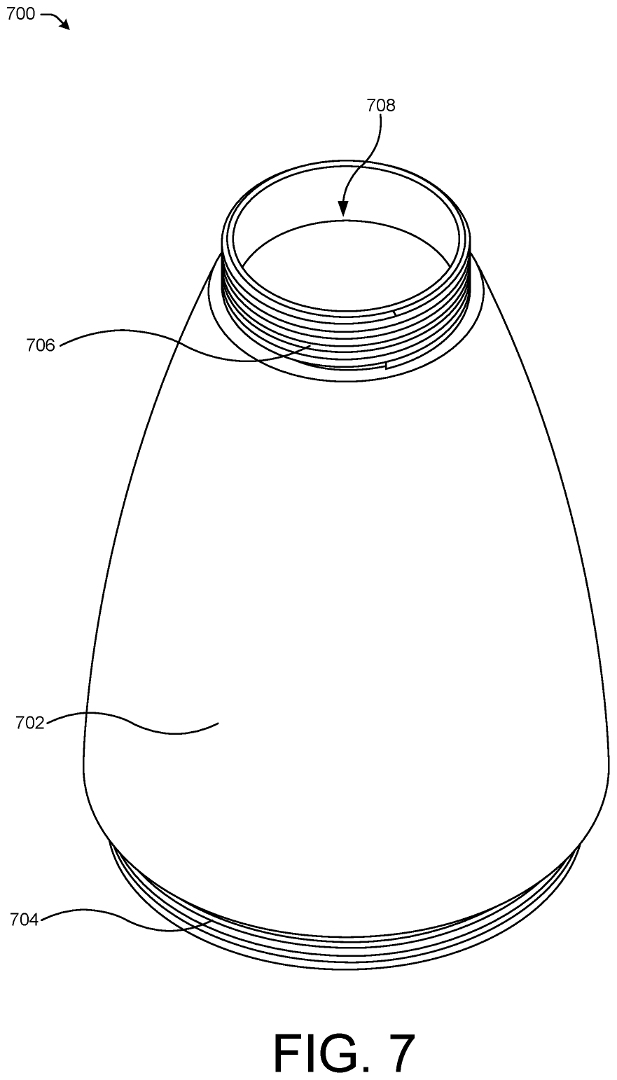

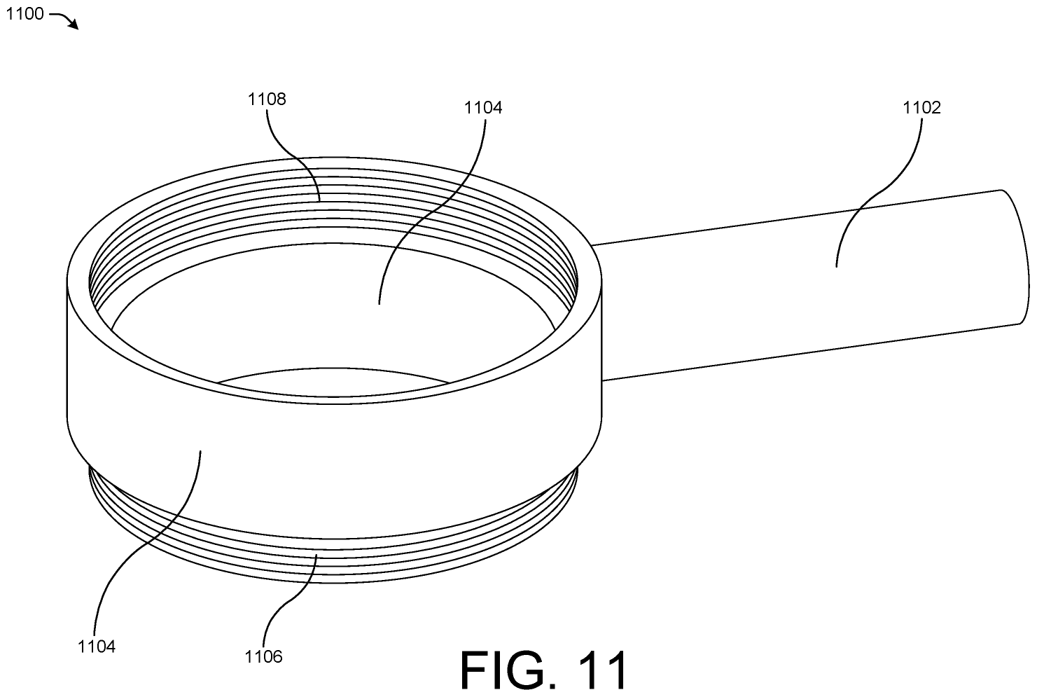

As depicted in FIG. 6, specifically, the first portion 200 may further include second threads 212 used to threadingly coupled the first portion 200 to the second portion 130 (e.g., the second portion 700 of FIGS. 7-10) via the handle coupler 120 (e.g., the handle coupler 1100 of FIGS. 11-16). As mentioned herein, the handle coupler 120 may include corresponding threads to mate with the second threads 212 of the first portion 200 as well as threads to mate with the second portion 130. In one example, the second threads 212 may include female threads to mate with corresponding male threads of the handle coupler 120. In this manner, the first portion 128 is coupled to the second portion 130 via the handle coupler 120 as will be described in more detail herein in connection with FIGS. 11 through 16.

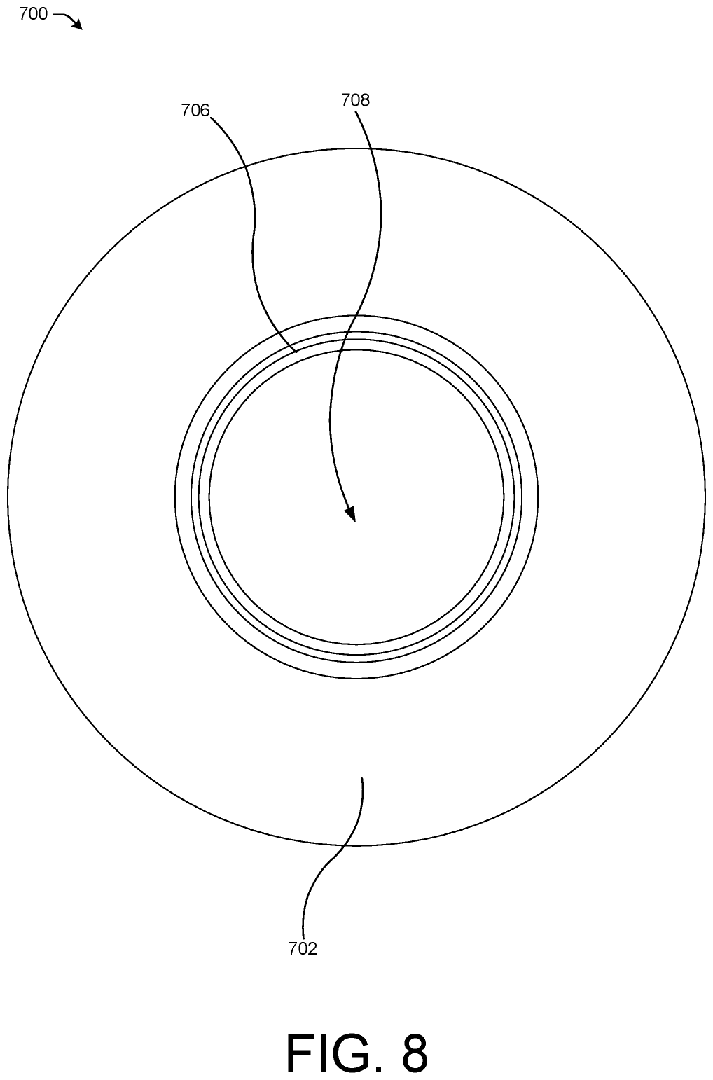

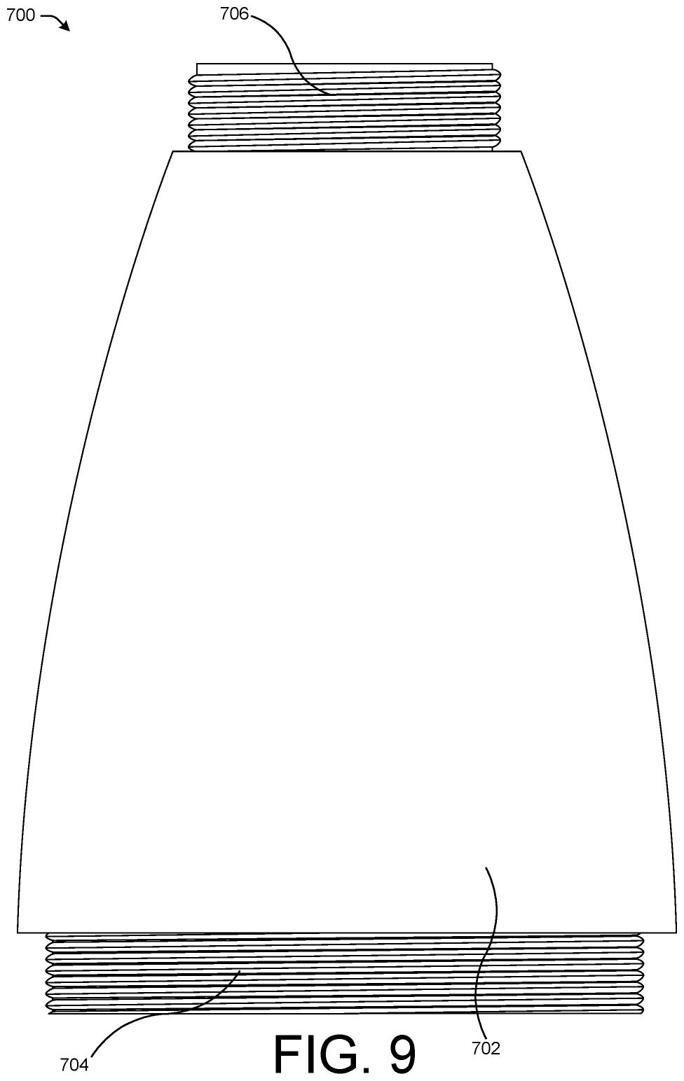

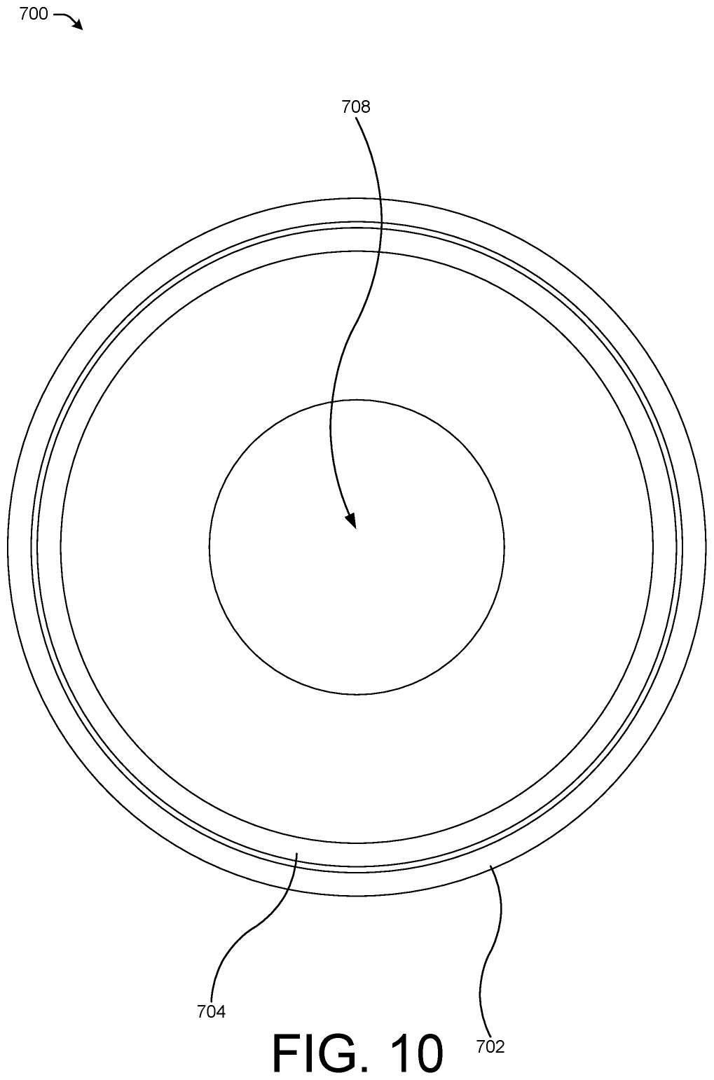

Turning now to a description of the second portion 130, FIG. 7 illustrates an isometric view of a second portion 700 of the main chamber 104 of the nozzle 102 of FIG. 1, according to an example of the principles described herein. FIG. 8 illustrates a top view of the second portion 700 of FIG. 7, according to an example of the principles described herein. FIG. 9 illustrates a side view of the second portion 700 of FIG. 7, according to an example of the principles described herein. FIG. 10 illustrates a bottom view of the second portion 700 of FIG. 7, according to an example of the principles described herein. The second portion 700, as depicted in FIGS. 7 through 11, includes a body 702 that forms the second half or hemisphere of the main chamber 104. Further, the second portion 700 may include first threads 704 to threadingly couple the handle coupler 120 (e.g., the handle coupler 1100 of FIGS. 11-16) to the second portion 700. The coupling of the second portion 700 to the handle coupler 120, in turn, allows the second portion 700 to be coupled indirectly to the first portion 200 via the handle coupler 120.

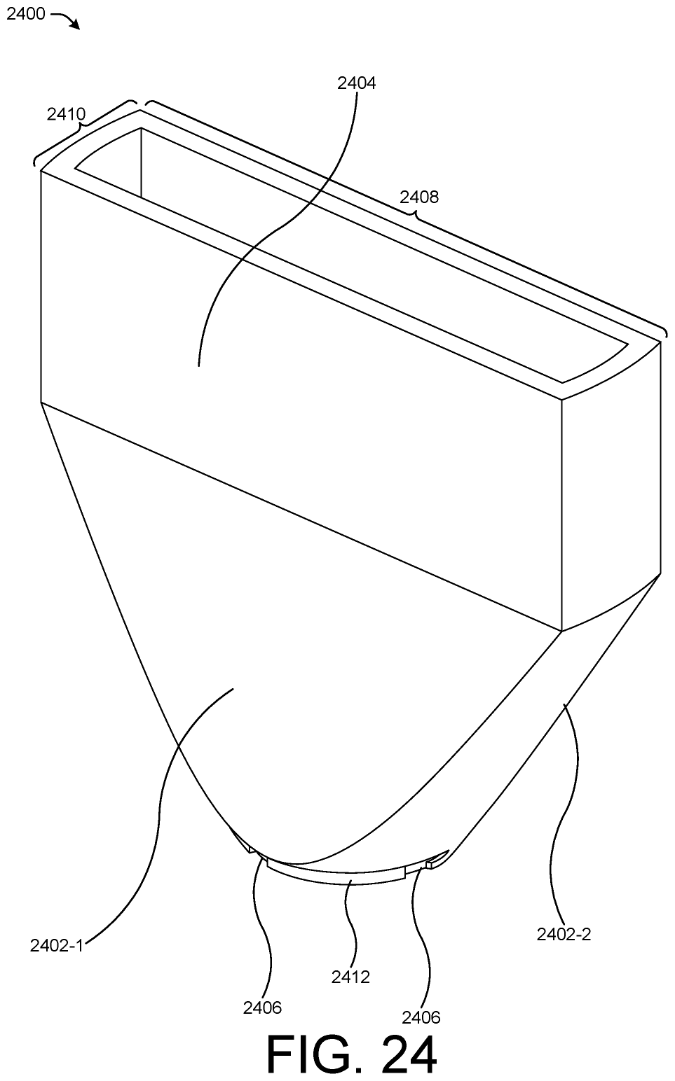

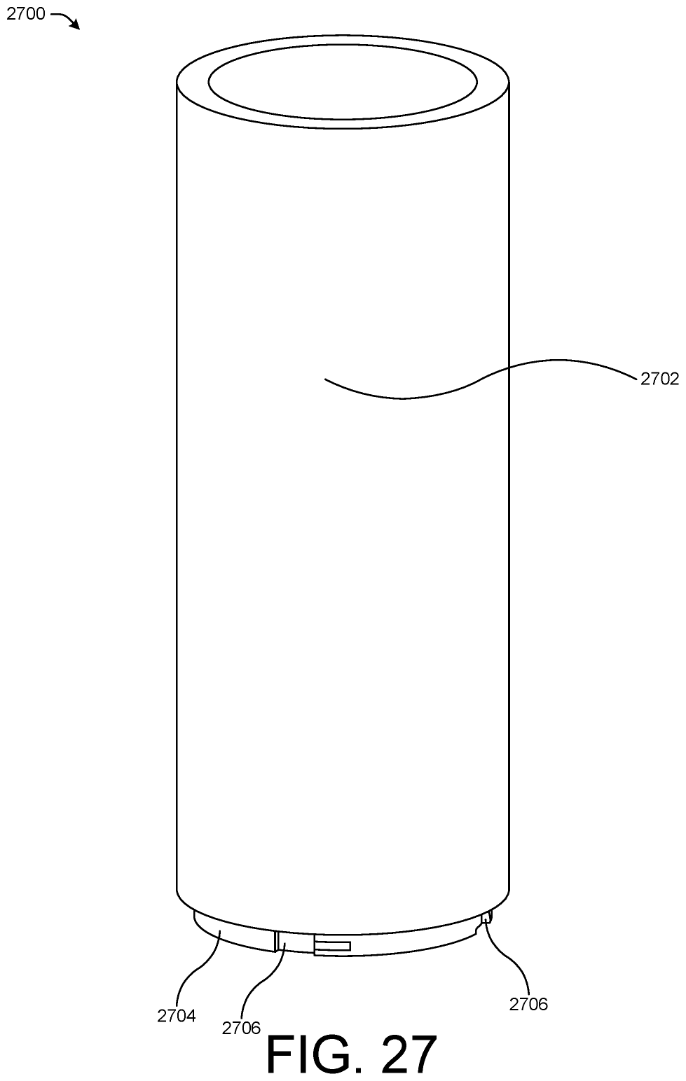

The second portion 700 may further include second threads 706 used to directly or indirectly couple the second portion 700 to a spray head 114 (e.g., the wide spray head 2400 of FIGS. 24-26 and/or the straight spray head 2700 of FIG. 27). As mentioned herein, the second threads 706 may be coupled to a number of intermediary coupling devices such as, for example, a first adapter 2000 depicted in FIGS. 20 and 21, a second adapter 2200 depicted in FIG. 22, and a 45 degree (°) adapter 2300 depicted in FIG. 23 in order to indirectly couple the second portion 700 to an a spray head 114 (e.g., the wide spray head 2400 of FIGS. 24-26 and/or the straight spray head 2700 of FIG. 27). In this manner, the second portion 700 is coupled to the spray head 114 directly or indirectly via the handle coupler 120 as will be described in more detail herein in connection with FIGS. 20 through 27.

The second portion 700 may further include an outlet 708 (e.g., outlet 112 of FIG. 1) defined therein. The outlet 708 defined in the second end of the main chamber 104 provides for the spray head 114 and any intermediary coupling devices may be fluidically coupled to the main chamber 104.

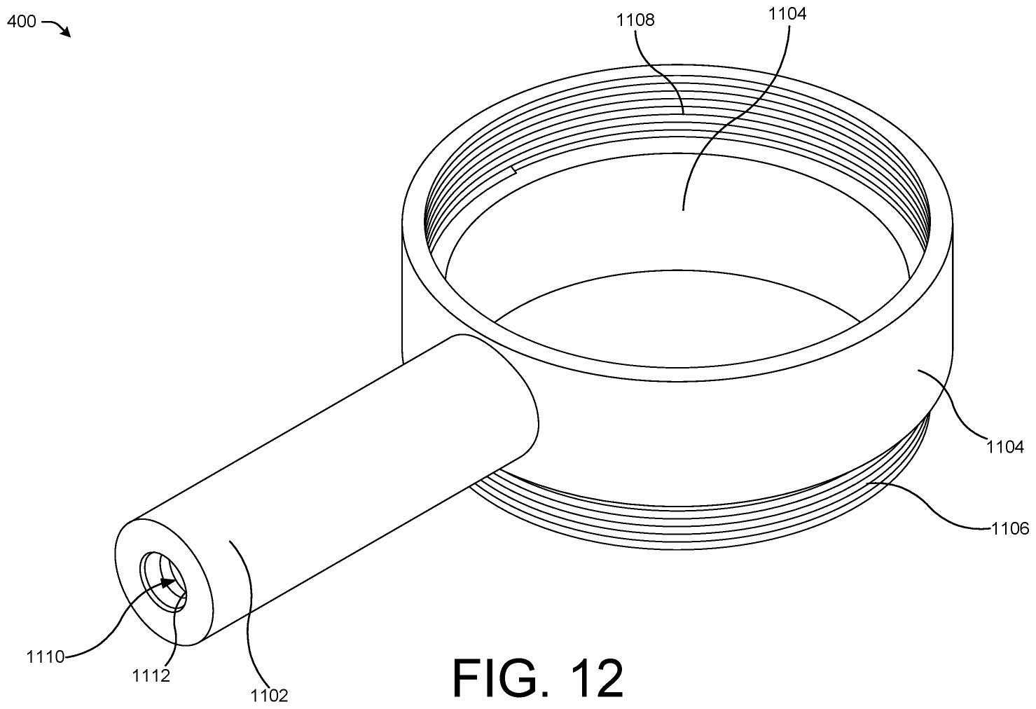

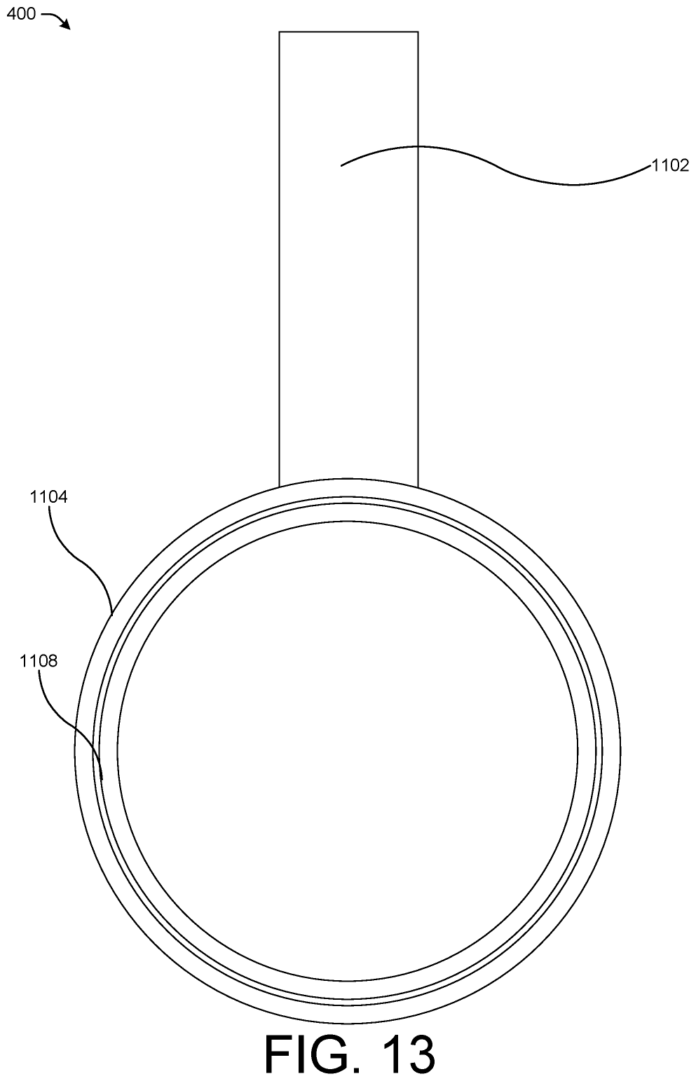

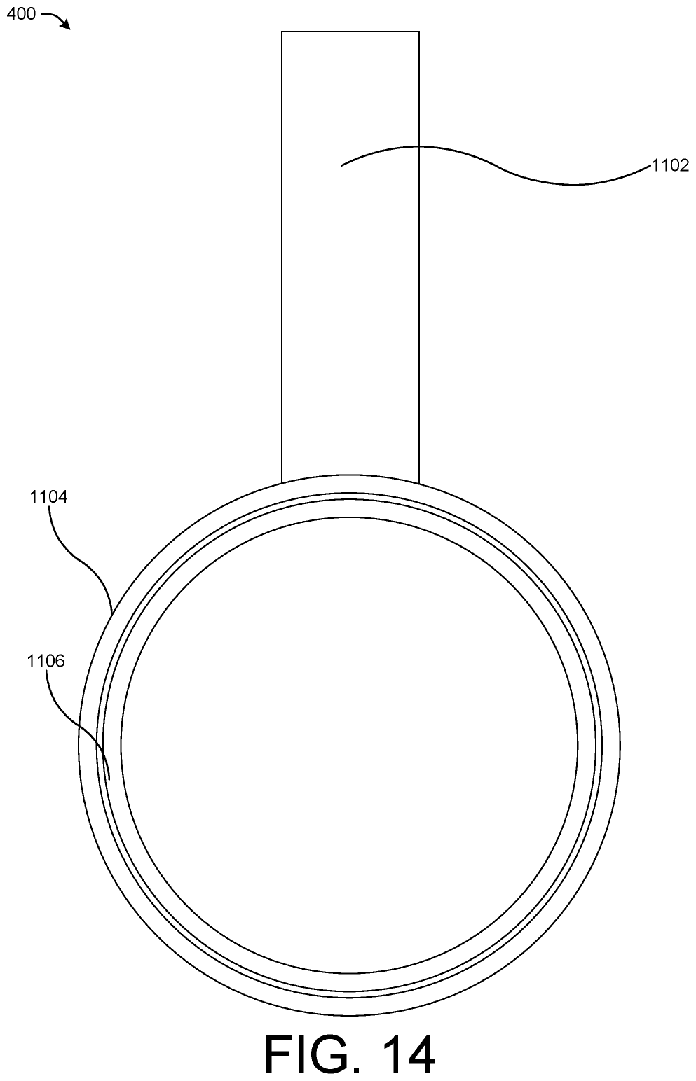

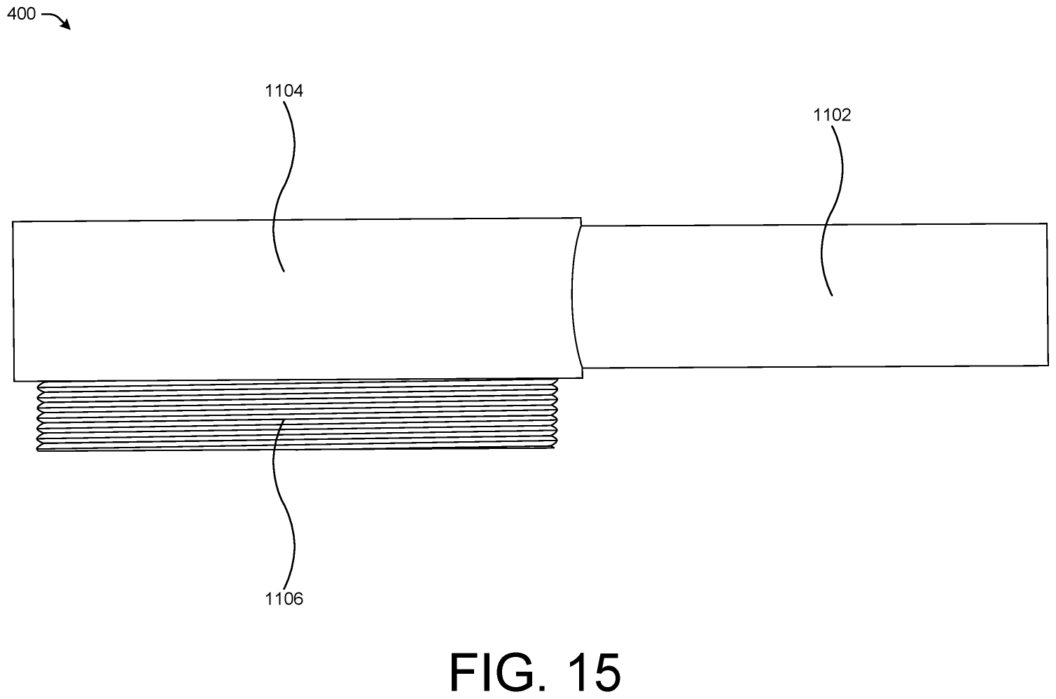

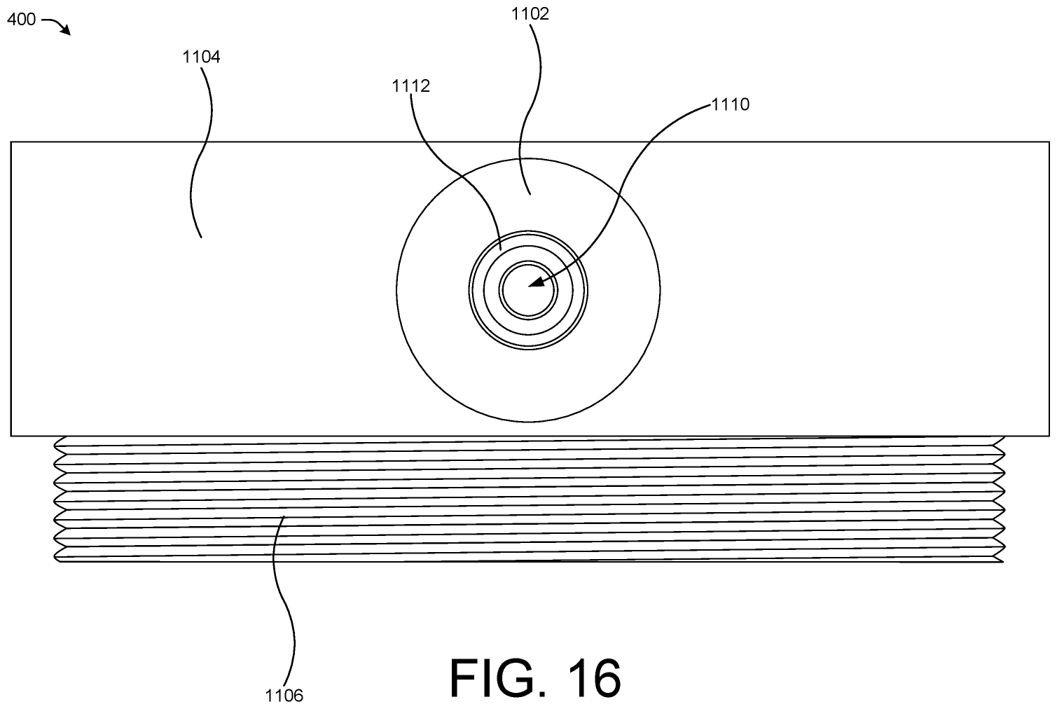

FIG. 11 illustrates an isometric view of a handle coupler 1100 (e.g., the handle coupler 120 of FIG. 1) for coupling the first portion 200 of FIGS. 2 through 6 and the second portion 700 of FIGS. 7 through 10, according to an example of the principles described herein. FIG. 12 illustrates an isometric view of the handle coupler 1100 of FIG. 11, according to an example of the principles described herein. FIG. 13 illustrates a top view of the handle coupler 1100 of FIG. 11, according to an example of the principles described herein. FIG. 14 illustrates a top view of the handle coupler 1100 of FIG. 11, according to an example of the principles described herein. FIG. 15 illustrates a first side view of the handle coupler 1100 of FIG. 11, according to an example of the principles described herein. FIG. 16 illustrates a second side view of the handle coupler 1100 of FIG. 11, according to an example of the principles described herein.

The handle coupler 1100 serves a plurality of functions within the nozzle 102 of the system 100. As a first function, the handle coupler 1100 serves to provide a means by which a user may grasp and control the nozzle 102. For example, the handle coupler 1100 may include one or more handles 1102 (e.g., the handle 132 of FIG. 1) coupled to a ring 1104.

The ring 1104 may include male threading 1106 to interface with the female threads (e.g., the second threads 212) of the first portion 200. The ring 1104 may further include female threading 1108 to interface with the male threads (e.g., the first threads 704) of the second portion 700. In this manner, the ring 1104 may couple to both the first portion 200 and the second portion 700 as an intermediary element. In one example the first portion 200, the second portion 700, and/or the handle coupler 1100 may be formed as a single monolithic unit such that assembly of these elements within the nozzle 102 may not be required. However, the ability to separate the first portion 200 from the second portion 700 allows for the internal spaces such as the first interior space 106 may be cleaned after the nozzle is used. Since the materials dispensed by the system 100 and the nozzle 102 include binding materials such as cementitious material, concrete, plaster, lime binder, clay, stabilized soil, other binding materials, geopolymers, and combinations thereof, it may be beneficial to clear and clean the nozzle 102 of such materials.

The handle coupler 1100 may further include a void 1110 defined in the handle 1102. The void 1110 may include a void threading 1112. The void threading 1112 may be used to allow a stanchion or rest to be coupled to the bottom of the handle 1102 to allow the user to support the nozzle 102 as the user applies the mixture of the binding material(s) and solid material(s) to a surface. In one example, the stanchion or rest may include a telescopic stanchion that allows the user to rest the nozzle 102 at different heights.

In the examples described herein, the threading of the first portion 128 and the second portion 130 to the handle coupler 1100 may be achieved such that when the threadings are fully engaged and/or seated, the elements align in a manner as depicted in FIG. 1. In one example, the female threads and the corresponding male threads within the system 100 may be aligned such that the alignment of the elements of the system is achieved.

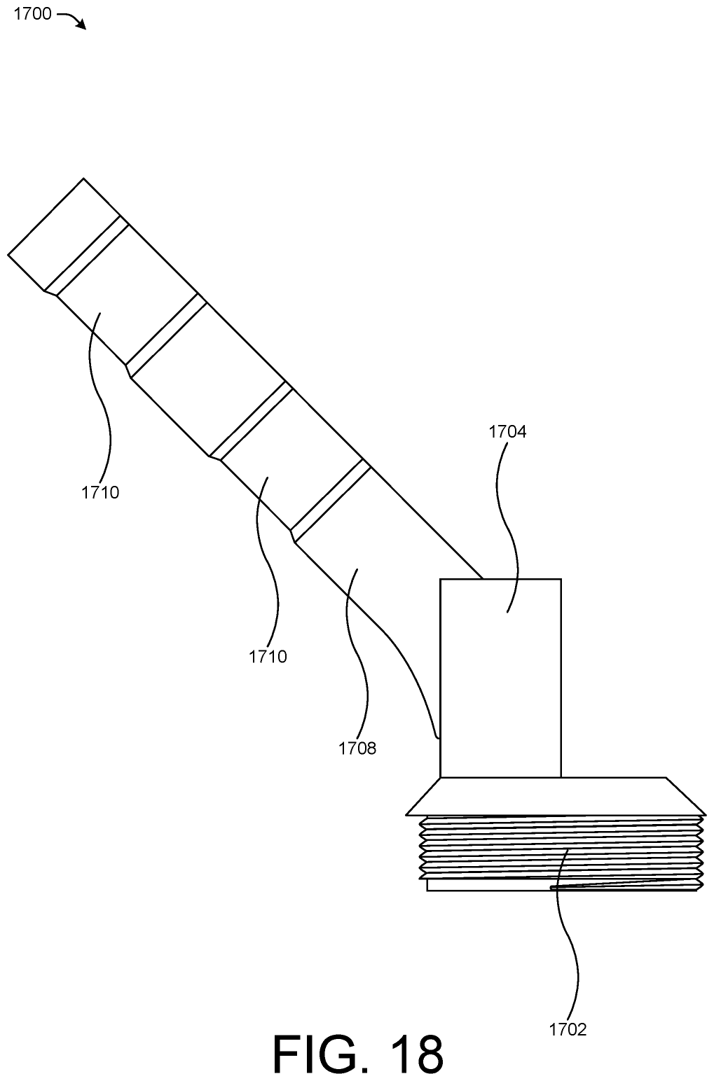

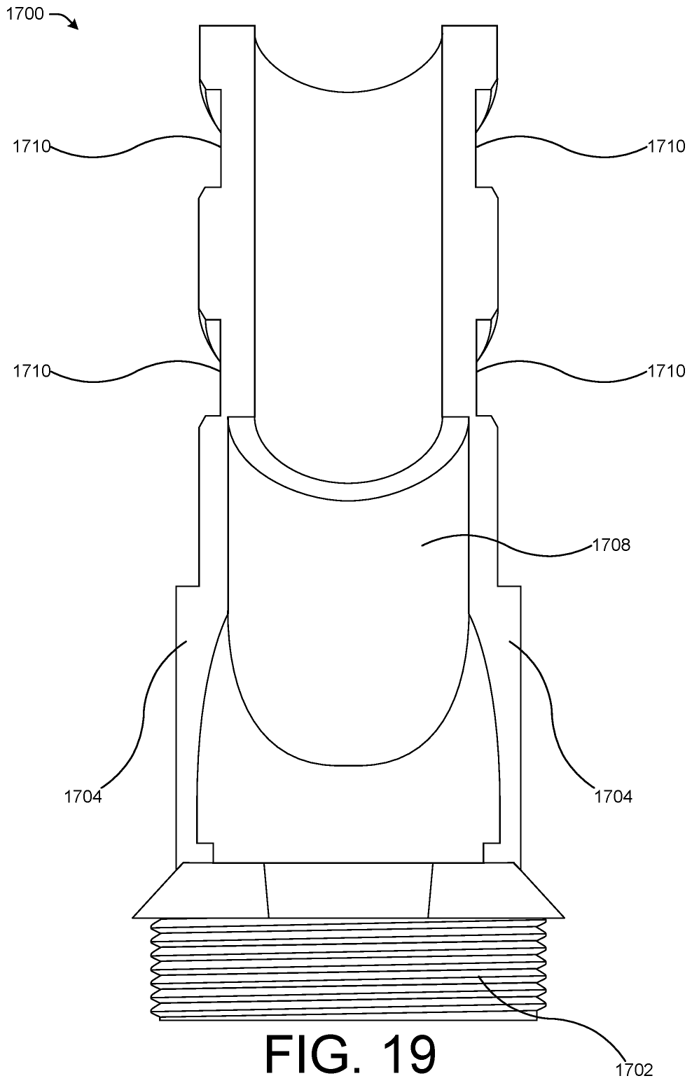

FIG. 17 illustrates an isometric view of a dispenser bracket 1700 for coupling a material sprayer (e.g., the fluid material dispenser 122 of FIG. 1) to the first portion 200 of FIG. 2 of the main chamber of the nozzle of FIG. 1, according to an example of the principles described herein. FIG. 18 illustrates a first side view of the dispenser bracket 1700 of FIG. 17, according to an example of the principles described herein. FIG. 19 illustrates a second side view of the dispenser bracket 1700 of FIG. 17, according to an example of the principles described herein. The dispenser bracket 1700 supports the material sprayer such as, for example, the fluid material dispenser 122 of FIG. 1 as the fluid material dispenser 122 is coupled to the first portion 200. This may reduce or eliminate damage to the fluid material dispenser 122. Further, the dispenser bracket 1700 may assist a user in coupling the fluid material dispenser 122 to the nozzle 102 as it provides guides to make coupling less cumbersome or difficult. Still further, the dispenser bracket 1700 may assist the user in managing hosing used in connection with the fluid material dispenser 122.

The dispenser bracket 1700 may include threads 1702. In the example of FIGS. 17-19, the threads 1702 may be male threads that may be capable of interfacing with mating first threads 206 of the first portion 206. In one example, the female threads of the first threads 206 of the first portion 206 mate with the threads 1702 of the dispenser bracket 1700 in order to couple the dispenser bracket 1700 to the first portion 200. In one example, the dispenser bracket 1700 may be threadingly coupled to the first portion 206 before or after the fluid material dispenser 122 is coupled to the dispenser bracket 1700.

In one example, a via 1706 defined in the dispenser bracket 1700 may be dimensioned to couple to the fluid material dispenser 122. In an example where the fluid material dispenser 122 is a Browning nozzle, the end of the Browning nozzle may seat within the via 1706 such that an engineering fit as described herein is created between the inner wall of the via 1706 and the outer circumference of the end of the Browning nozzle.

In one example, the dispenser bracket 1700 may further include a number of guides 1704 located on opposing sides of the via 1706. The guides 1704 may assist a user in aligning the fluid material dispenser 122 with the via 1706 so that the user may more easily and conveniently insert the end of the fluid material dispenser 122 into the via 1706.

The dispenser bracket 1700 may further include a track 1708 in which the fluid material dispenser 122 may be seated. In the example of FIGS. 17 through 19, the track 1708 is curved to accommodate for a matching curvature in the fluid material dispenser 122. However, in the examples described herein, the track 1708 may have any shape to allow for the accommodation of any fluid material dispenser 122 that may have a different form factor.

A number of strap voids 1710 may be defined in an outer surface of the track 1708 of the dispenser bracket 1700. The strap voids 1710 may be used to guide and secure straps to the dispenser bracket 1700. The straps may be used to secure the fluid material dispenser 122 to the track 1708 of the dispenser bracket 1700. In one example, the straps may include metal clasps, nylon strapping, and zip ties, among other strapping devices. By securing the fluid material dispenser 122 to the dispenser bracket 1700 in this manner causes the alignment of the fluid material dispenser 122 with in the via 1706 to continue to be aligned and retained within the via 1706. Further, securing the fluid material dispenser 122 to the dispenser bracket 1700 in this manner allows the user to grasp the coupled fluid material dispenser 122 and dispenser bracket 1700 as one unit while using the nozzle

FIG. 20 illustrates an isometric view of a first adapter 2000 for coupling to an outlet 708 (e.g., outlet 112 of FIG. 1) defined in the second portion 700 (e.g., the second portion 130) of the nozzle of FIG. 1, according to an example of the principles described herein. FIG. 21 illustrates a side view of the first adapter 2000 of FIG. 20, according to an example of the principles described herein. The first adapter 2000 provides for a means by which a number of spray heads 114 (e.g., the wide spray head 2400 of FIGS. 24-26 and/or the straight spray head 2700 of FIG. 27) may be coupled to the main chamber 104 of the nozzle 102. Further, the first adapter 2000 provides for a means by which the dispenser bracket 1700 and/or the fluid material dispenser 122 may be coupled to the main chamber 104 of the nozzle 102.

The first adapter 2000 may include a body 2002. A number of threads 2004 may be formed on a first side of the body 2002. In one example, the threads 2004 of the first adapter 2000 may be male threads that may couple or mate with the first threads 206 of the first inlet 204 of the first portion 200 to provide for a different coupling interface with respect to the dispenser bracket 1700 or may provide for an adapter for use with the dispenser bracket 1700. As to the different interface, a second side of the body 2002 may include a locking interface 2006 including, for example, a channel and tab pair that may mate with corresponding tab elements included on the a spray head 114 (e.g., the wide spray head 2400 of FIGS. 24-26 and/or the straight spray head 2700 of FIG. 27), the dispenser bracket 1700 and/or the fluid material dispenser 122. In this manner, the first adapter 2000 may assist in coupling elements of the nozzle 102 described herein to the main chamber 104.

FIG. 22 illustrates an isometric view of a second adapter 2200 for coupling to an outlet 708 (e.g., outlet 112 of FIG. 1) defined in the second portion 700 (e.g., the second portion 130) of the nozzle of FIG. 1, according to an example of the principles described herein. The second adapter 2200 may include a body 2202. A number of threads 2204 may be defined on a first side of the body 2202. In one example, the threads 2204 may be female threads that mate with the second threads 706 being male threads that mate with the threads 2204.

A second end of the body 2202 of the second adapter 2200 may include a locking interface 2206 including, for example, a number of tabs that interface with a channel of a channel and tab pair that may mate with corresponding tab elements included on the a spray head 114 (e.g., the wide spray head 2400 of FIGS. 24-26 and/or the straight spray head 2700 of FIG. 27), the dispenser bracket 1700 and/or the fluid material dispenser 122. In this manner, the second adapter 2200 may assist in coupling elements of the nozzle 102 described herein to the main chamber 104.

FIG. 23 illustrates an isometric view of a 45° adapter 2300 for coupling to an outlet 708 (e.g., outlet 112 of FIG. 1) defined in the second portion 700 (e.g., the second portion 130) of the nozzle of FIG. 1, according to an example of the principles described herein. The 45° adapter 2300 may include a curved body 2302. At a first end of the curved body 2302 of the 45° adapter 2300 may include a number of tabs 2204 that interface with a channel of a channel and tab pair included on the a spray head 114 (e.g., the wide spray head 2400 of FIGS. 24-26 and/or the straight spray head 2700 of FIG. 27), the dispenser bracket 1700 and/or the fluid material dispenser 122. Further, the 45° adapter 2300 may include a number of channels 2206 that interface with a tab of a channel and tab pair included on the a spray head 114 (e.g., the wide spray head 2400 of FIGS. 24-26 and/or the straight spray head 2700 of FIG. 27), the dispenser bracket 1700 and/or the fluid material dispenser 122. In this manner, the 45° adapter 2300 may couple elements of the nozzle 102 together while allowing for an angle between, for example, the main chamber 104 and the spray head 114 (e.g., the wide spray head 2400 of FIGS. 24-26 and/or the straight spray head 2700 of FIG. 27), the dispenser bracket 1700 and/or the fluid material dispenser 122.

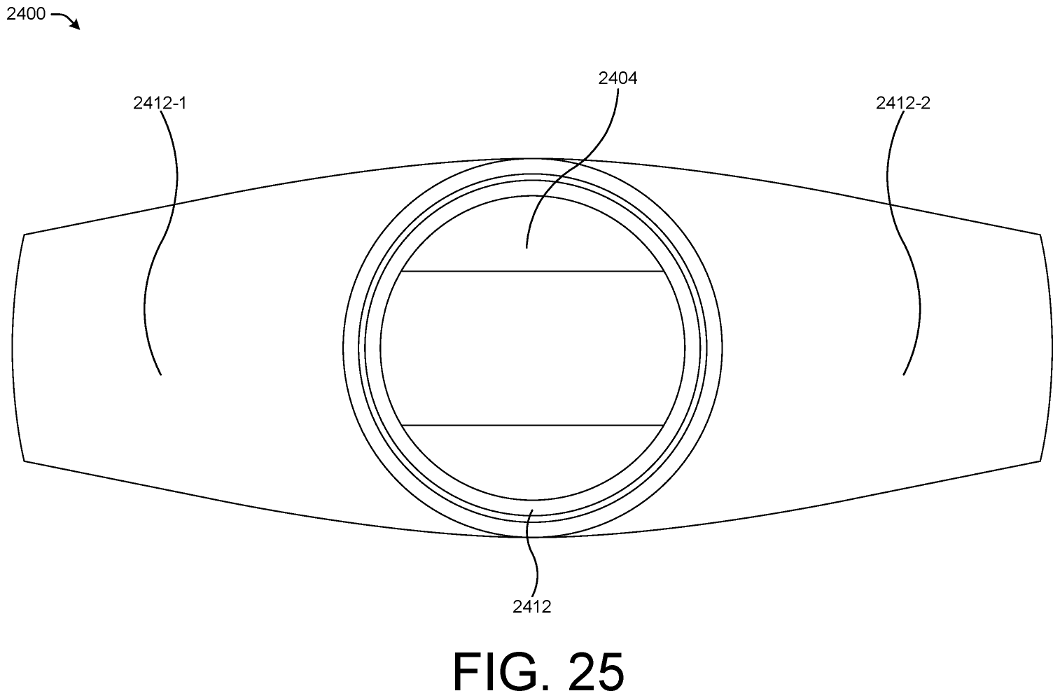

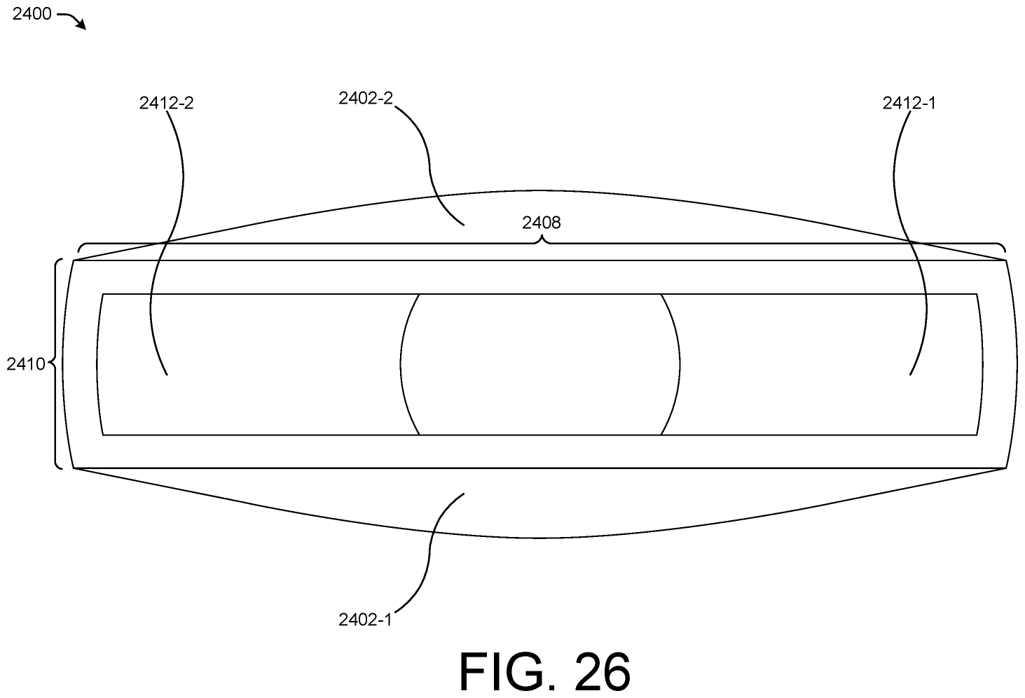

FIG. 24 illustrates an isometric view of a wide adapter 2400 couplable to an outlet 708 (e.g., outlet 112 of FIG. 1) defined in the second portion 700 (e.g., the second portion 130) of the nozzle of FIG. 1, according to an example of the principles described herein. FIG. 25 illustrates a bottom view of the wide adapter 2400 of FIG. 24, according to an example of the principles described herein. FIG. 26 illustrates a top view of the wide adapter 2400 of FIG. 24, according to an example of the principles described herein. The wide adapter 2400 may be used in association with the system 100 in order to create a laminar flow that may be used to more effectively and efficiently dispense the binding material(s) and solid material(s) mixed within the main chamber 104 onto a surface.

The wide adapter 2400 may include a cylindrical interface 2412 that includes a number of channels 2406 that interface with a tab of a channel and tab pair included on the first adapter 2000 depicted in FIGS. 20 and 21, the second adapter 2200 depicted in FIG. 22, the 45° adapter 2300 depicted in FIG. 23, and/or the outlet 112 defined in the second end of the main chamber 104.

The wide adapter 2400 may also include a tapering body including a first side 2402-1, a second side 2412-1, a third side 2402-2, and a fourth side 2412-2. The first side 2402-1 and the third side 2402-2 may be opposite with respect to one another and may be non-parallel such that a first distance between the first side 2402-1 and the third side 2402-2 at the cylindrical interface 2412 is larger with respect to a second distance between the first side 2402-1 and the third side 2402-2 at a mouth 2404 of the wide adapter 2400.

Further, the second side 2412-1 and the fourth side 2412-2 may also be opposite with respect to one another and may be non-parallel such that a first distance between the second side 2412-1 and the fourth side 2412-2 at the cylindrical interface 2412 is smaller with respect to a second distance between the second side 2412-1 and the fourth side 2412-2 at the mouth 2404 of the wide adapter 2400. The shape of this tapering body including the first side 2402-1, the second side 2412-1, the third side 2402-2, and the fourth side 2412-2 contributes to the create of the laminar flow that causes the effective and efficient dispensing of the mixed binding material(s) and solid material(s) from the main chamber 104 onto a surface.

As depicted in FIGS. 24 through 26, the cylindrical interface 2412, the first side 2402-1, the second side 2412-1, the third side 2402-2, and the fourth side 2412-2, and the mouth 2404 define the second interior space 126 in fluid communication with the first interior space 106.

In one example, the mouth 2404 may include an approximately cuboid shape such that the mouth 2404 has a rectangular cross section. The mouth 2404 may have a width 2408 of between 100 mm and 600 mm, and a height 2410 of between 20 mm and 100 mm.

FIG. 27 illustrates an isometric view of a long output tube 2700 couplable to the outlet of the nozzle of FIG. 1, according to an example of the principles described herein. The long output tube 2700 may be used in association with the system 100 in order to create a laminar flow that may be used to more effectively and efficiently dispense the binding material(s) and solid material(s) mixed within the main chamber 104 onto a surface. The long output tube 2700 may provide a spray pattern that is different from the spray pattern provided by the wide adapter 2400 but may still produce a sufficient laminar flow to causes the effective and efficient dispensing of the mixed binding material(s) and solid material(s) from the main chamber 104 onto a surface.

The long output tube 2700 may include a cylindrical interface 2704 that includes a number of channels 2706 that interface with a tab of a channel and tab pair included on the first adapter 2000 depicted in FIGS. 20 and 21, the second adapter 2200 depicted in FIG. 22, the 45° adapter 2300 depicted in FIG. 23, and/or the outlet 112 defined in the second end of the main chamber 104.

The long output tube 2700 may further include a body 2702. The body 2702 may be of any length to allow for the extension of the long output tube 2700 may extend to any desired length past the main chamber 104. Further, as depicted in FIG. 27, the cylindrical interface 2704 and the body may define the second interior space 126 in fluid communication with the first interior space 106.

### CONCLUSION

The examples described herein provide a nozzle that includes a main chamber in which the fluid material(s) and the solid material(s) may be mixed in preparation for expulsion out of the nozzle via the spray head. The spray head may assist in creating a laminar flow that effectively and efficiently applies the mixed fluid material(s) and the solid material(s) to a surface. The enlarged main chamber and tapered spray head included in the system creates an effective spray pattern and allows for a more efficient coating of the solid material(s). In one example, a number of interchangeable spray heads may be employed in order to shape the stream of mixed fluid material(s) and the solid material(s) to achieve more effective coverage resulting in lower production and labor time when compared to conventional systems.

In one example, a handle may be provided that includes female threading at the bottom to allow for a stanchion to be coupled thereto for ease in hefting the nozzle. Further, adding a short extension to the handle via the female threading to allow the user to make a single pass of a surface from the bottom of the surface (e.g., a wall) to the top of, for example, an eight foot wall with less stress on the user and better accuracy when compared to conventional systems.

While the present systems and methods are described with respect to the specific examples, it is to be understood that the scope of the present systems and methods are not limited to these specific examples. Since other modifications and changes varied to fit particular operating requirements and environments will be apparent to those skilled in the art, the present systems and methods are not considered limited to the example chosen for purposes of disclosure, and covers all changes and modifications which do not constitute departures from the true spirit and scope of the present systems and methods.

Although the application describes examples having specific structural features and/or methodological acts, it is to be understood that the claims are not necessarily limited to the specific features or acts described. Rather, the specific features and acts are merely illustrative of some examples that fall within the scope of the claims of the application.

What is claimed is:

1. A hemperete spraying device comprising:
a spray nozzle comprising:
a main chamber defining a first internal space;
a first inlet defined in a first end of the main chamber;
a second inlet to receive a solid material into the main chamber; and
an outlet defined in a second end of the main chamber; and
a material sprayer coupled to a first end of the main chamber to dispense a fluid material,
wherein:
the material sprayer is coupled to the first end of the main chamber upstream from the second inlet, and
the main chamber configured to mix the solid material with the fluid material.

2. The hemperete spraying device of claim 1, further comprising a spray head coupled to the outlet, the spray head comprising a second internal space.

3. The hemperete spraying device of claim 2, wherein the spray head comprises:
a cylindrical interface to interface with the outlet;
a tapering body comprising a first side, a second side, a third side, and a fourth side; and
a mouth,
wherein the cylindrical interface, the first side, the second side, the third side, the fourth side, and the mouth define the second internal space.

4. The hemperete spraying device of claim 3, wherein:
the tapering body comprise the first side and the third side, the first side and the third side being opposite with respect to one another,
the second side and the fourth side are opposite with respect to one another, and
the first side and the third side taper from the cylindrical interface to the mouth such that a first distance between the first side and the third side at the cylindrical interface is larger with respect to a second distance between the first side and the third side at the mouth.

5. The hemperete spraying device of claim 3, wherein the mouth comprises a rectangular cross section.

6. The hemperete spraying device of claim 1, wherein the main chamber comprises an oval cross section.

7. The hemperete spraying device of claim 1, wherein the solid material is a plant-based material.

8. The hemperete spraying device of claim 1, wherein the solid material is hemp, hemp hurd, kenaf, chaff, cellulose, fibers, straw, wheat stalk, oat stalk, rye stalk, barley stalk, buckwheat stalk, or combinations thereof.

9. The hemperete spraying device of claim 1, wherein the fluid material is a binding material to bind the solid material.

10. The hemperete spraying device of claim 1, wherein the fluid material is a cementitious material, a concrete, a plaster, a lime binder, a clay, a stabilized soil, or combinations thereof.

11. The hemperete spraying device of claim 1, wherein the spray nozzle is a Browning nozzle.

12. A nozzle comprising:
a main chamber defining a first internal space;
a first inlet defined in a first end of the main chamber to couple to a material sprayer;
a second inlet to receive a solid material into the main chamber; and
an outlet defined in a second end of the main chamber;
wherein:
the first inlet upstream from the second inlet to allow a fluid material to enter the main chamber before the solid material, and
the main chamber configured to mix the solid material with the fluid material.

13. The nozzle of claim 12, further comprising a spray head coupled to the outlet, the spray head comprising a second internal space.

14. The nozzle of claim 13, wherein the spray head comprises:
a cylindrical interface to interface with the outlet;
a tapering body comprising a first side, a second side, a third side, and a fourth side; and
a mouth,
wherein the cylindrical interface, the first side, the second side, the third side, the fourth side, and the mouth define the second internal space.

15. The nozzle of claim 14, wherein:
the tapering body comprise the first side and the third side, the first side and the third side being opposite with respect to one another,
the second side and the fourth side are opposite with respect to one another, and
the first side and the third side taper from the cylindrical interface to the mouth such that a first distance between the first side and the third side at the cylindrical interface is larger with respect to a second distance between the first side and the third side at the mouth.

16. The nozzle of claim 14, wherein the mouth comprises a rectangular cross section.

17. The nozzle of claim 12, wherein the main chamber comprises an oval cross section.

18. The nozzle of claim 14, wherein the main chamber and the mouth comprise a wall thickness between 0.1 millimeters (mm) and 50 mm.

19. The nozzle of claim 14, wherein the mouth comprises:
a width of between 100 mm and 600 mm; and
a height of between 20 mm and 100 mm.

20. The nozzle of claim 12, wherein the first inlet is configured to couple to the material sprayer, the material sprayer comprising a Browning nozzle.
